(19) United States
(12) Patent Application Publication
(10) Pub. No.: US 2026/0296602 A1
(43) Pub. Date: Oct. 1, 2026

(54) FLOATING PLATFORM, IN PARTICULAR FOR AN OFFSHORE WIND TURBINE, HAVING IMPROVED STABILITY

(71) Applicant: COFFRATHERM, PUGET-VILLE (FR)

(72) Inventors: Philippe DURAND, PUGET-VILLE (FR); Stéphanie DURAND, BLACKWOOD (AU)

(21) Appl. No.: 19/478,965

(22) PCT Filed: Apr. 26, 2024
(86) PCT No.: PCT/EP2024/061641

§ 371 Date: Oct. 27, 2025

(30) Foreign Application Priority Data
Apr. 28, 2023 (FR) FR2304353

(51) Int. Cl. B63B 35/44; B63B 21/50; B63B 22/00; B63B 75/00; F03D 13/25

(52) U.S. Cl. CPC B63B 35/44; B63B 21/50; B63B 22/00; B63B 75/00; F03D 13/256; B63B 2035/446; F05B 2240/93

(57) ABSTRACT

A floating platform, in particular a platform for a wind turbine, which affords improved stability by an arrangement of anchoring tendons. The floating platform includes a float, tendons, fixing mechanisms for attaching an upper end of each of the tendons to the float, and anchoring mechanisms for fixing a lower end of each of the tendons to a seabed. The tendons include tendons of a first type, arranged vertically, and tendons of a second type, arranged obliquely, between their attachment and anchoring mechanisms. The tendons are arranged alternately around a main axis and designed so that, in an operational position, the float is kept submerged at a depth below the surface of the water, and, at least the vertical tendons are kept taut. A method for assembling such a platform and the wind turbine thereof as well as to a method for anchoring the platform offshore.

### FIELD OF THE INVENTION

This invention relates to the field of offshore platforms, in particular platforms acting as support for offshore wind turbines.

### BACKGROUND

In particular, a platform acting as support for a wind turbine installed offshore must be as stable as possible to guarantee production of electrical energy, even under conditions of strong swell or strong wind within the limits of use set by the manufacturer. In fact, above a certain wind speed, for example eighty kilometres per hour, the system is automatically shut down.

In addition, a more stable platform provides easier access to the wind turbine; the maintenance cost of the wind turbine is therefore reduced. Also, by reducing the forces borne by the wind turbine, the need for servicing and the wear are reduced and its lifetime is increased, which increases its productivity.

### SUMMARY

One objective of the invention is to propose a floating platform having improved stability and a method for installing an offshore wind turbine using such a platform.

According to a first object of the invention, a floating platform, in particular an offshore platform, intended to support equipment and organised around a substantially vertical main axis, comprises a float, tendons, fixing means for attaching an upper end of each of the tendons to the float and anchoring means for fixing a lower end of each of the tendons to a seabed, the tendons comprising at least three tendons of a first type, arranged vertically, and at least three tendons of a second type, arranged obliquely, between their attachment means and their anchoring means, the types of tendons being arranged alternately around the main axis and being designed so that, in an operational position, the float is kept submerged at a depth below the mean surface of the water, and, at least the vertical tendons are kept taut.

Preferably, all the oblique tendons form with the main axis the same angle, preferably greater than five degrees.

The oblique tendons can be rigid rods, preferably tubular. Advantageously, each end of each of the tendons is hinged to its fixing or anchoring means by ball joint means. Also advantageously, the attachment means are designed to transmit only tensile forces to the upper ends of the oblique tendons.

The oblique tendons can also consist of strands of a continuous cable stretched between pulleys carried by the float and pulleys carried by respective anchors.

The float is preferably of revolution around the main axis; it can be annular.

The platform can comprise an extension and a seat for the equipment, this seat being arranged on the extension, the extension extending upwards from the float, and being designed so that in the position in which the platform is used, there is an air draught under the seat. Advantageously, the extension comprises swell and wind transparency means, preferably a lattice structure, preferably a structure comprising posts and substantially horizontal bars connecting the posts together. Preferably, the extension is substantially of revolution around the main axis.

In addition, the platform can comprise inflatable buoy means capable of ensuring sufficient flotation of the platform if the float is fully ballasted or partially ballasted. Such buoy means are particularly useful during the phase of attaching the tendons or if an incident reduces the submerged volume of the platform.

A second object of the invention relates to an assembly comprising a platform according to the invention and equipment supported by this platform.

If the platform of this assembly comprises a seat, the equipment can comprise a base which forms swivelling means with the seat of the platform. The equipment can then comprise counterweight means which extend downwards from the base through the platform, these counterweight means preferably comprising a rod extending downwards from the base and a mass fixed to a lower end of the rod, the seat comprising an axial passage for this rod. The equipment can be a wind turbine comprising a propeller having an axis of rotation and the swivelling means can have a centre of rotation substantially on the axis of rotation.

A third object of the invention relates to a method for assembling a platform according to the invention, comprising:
providing a dock;
arranging several assembly stations along the dock;
providing a submersible barge;
placing the barge at one or more stations to manufacture the float; then,
placing the barge at one or more stations to assemble the extension and the seat; then,
placing the barge at one or more stations to assemble the equipment on said platform; then,
placing the barge on another station; then
ballasting the barge until the float alone ensures the flotation of the assembly thus assembled.

A fourth object of the invention relates to a method for mooring an assembly according to the invention on a site chosen to operate this assembly, comprising the following steps:
placing the anchoring means according to a template, at a desired position;
fixing the tendons to the anchoring means;
bringing the assembly by floating above the position;
inflating the buoy means;
ballasting the float until it is sufficiently submerged;
fixing the upper ends of the tendons to the float;
deballasting the float;
deflating the buoy means.

### BRIEF DESCRIPTION OF THE DRAWINS

Embodiments and variants will be described below, given as non-limiting examples, and referring to the attached drawings in which:

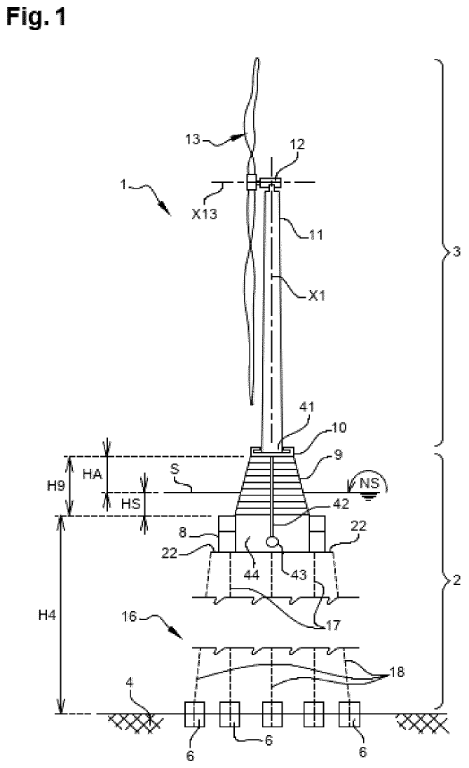

FIG. 1 is a diagrammatic elevation view of an assembly comprising a wind turbine mounted on a floating platform according to the invention;

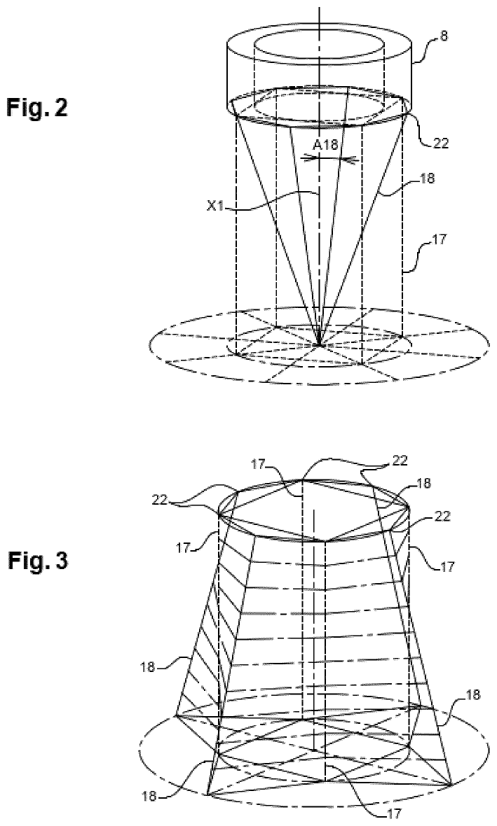

FIG. 2 is a diagrammatic view of an underwater float for the platform of FIG. 1 and of a first mode of arrangement for these tendons;

FIG. 3 is a diagrammatic view of a float for the platform of FIG. 1 and of a second mode of arrangement for these tendons;

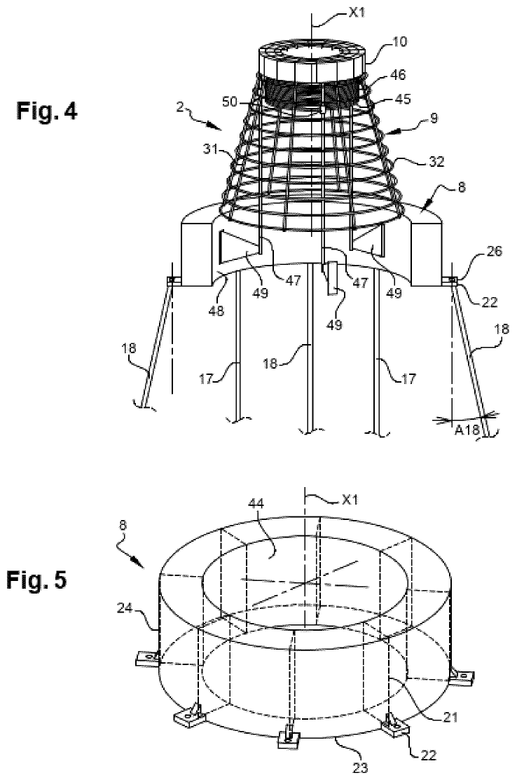

FIG. 4 is a diagrammatic elevation, perspective and partially cut-away view, of the platform of FIG. 1;

FIG. 5 is a diagrammatic elevation and perspective view of the float of the platform of FIG. 1;

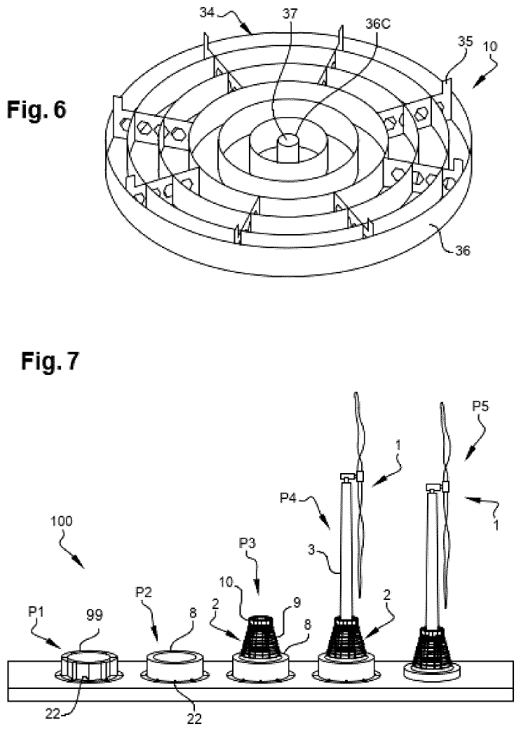

FIG. 6 is a diagrammatic elevation and perspective view of a swivelling framework for the platform of FIG. 1;

FIG. 7 is a diagrammatic elevation and perspective view showing a method and assembly stations, at dock, for the assembly of FIG. 1;

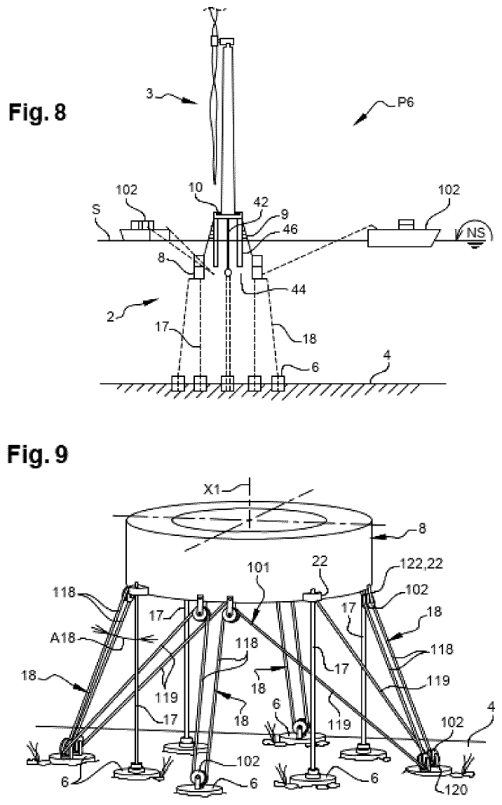

FIG. 8 is a diagrammatic elevation view of a step of positioning at sea the assembly of FIG. 1; and,

FIG. 9 is a diagrammatic view of an underwater float for the platform of FIG. 1 and of a second embodiment for the tendons, these tendons consisting of a hoist system.

In particular, the terms “top”, “bottom”, “upper” and “lower”, “horizontal” and “vertical” and other terms of the same type can be used arbitrarily in this description and generally refer to the positions shown on the figures.

### DETAILED DESCRIPTION

FIG. 1 shows an offshore wind power generation assembly 1. This assembly is substantially symmetrical around a main vertical axis X1 and comprises in particular a floating platform 2 and a wind turbine 3. The wind turbine rests on the platform 2. The platform is anchored to the seabed 4 by anchors 6.

The platform comprises an annular float 8 around the main axis X1; in the position of use shown on FIG. 1, this float is kept submerged at an immersion height HS, measured from an upper surface of the float to a mean level NS of the surface S of the water. It also comprises an extension 9 mounted on the float and extending over a height H9 greater than the immersion height HS, so that it culminates at an air height HA=H9−HS, above the mean water level NS. The immersion height HS is chosen so that the forces of the swell are felt very little or not at all by the float. Typically the immersion height is chosen between eight metres and fifteen metres, depending on the location of the platform.

This float is watertight; it comprises a flotation volume calculated so as to define an Archimedes thrust greater than the total weight of the assembly 1, increased by the values of forces to which it can be subjected under the strongest foreseeable storm conditions.

The platform further comprises, installed at the top of the extension 9, a seat 10 to install equipment thereon. In the example shown, the equipment carried by the platform is the wind turbine 3. The wind turbine comprises a hollow, tubular mast 11, which extends upwards from the seat 10, a nacelle 12, arranged at the top of the mast 11 and a three-blade propeller 13 fixed to the nacelle 12. The propeller 13 is movable around a substantially horizontal axis of rotation of the propeller X13.

The water depth H4 under the float 8 and above the seabed 4 can be greater than seventy metres. The platform comprises a mooring system 16 for fixing to the anchors 6. This system comprises eight tendons 17, 18 including four vertical tendons 17 and four oblique tendons 18.

The tendons used in the example shown on FIGS. 1 and 4 are substantially rigid metal tubes whose length is adapted to the irregularities of the seabed 4; since the resulting length differences are small compared with the depth H4, they are negligible and do not have a significant impact on the operation of the mooring system. The diameter of the tubes is determined by their mechanical characteristics which allow them to remain within the elastic limit under maximum stress. In the example, these tubes have a diameter of eight hundred millimetres and a thickness of thirty millimetres.

In the example shown on FIG. 9, the oblique tendons 18 consist of a continuous cable connected to the anchors 6 and to the float 8 by a pulley system; this system of oblique tendons consisting of a cable and pulley system can in particular absorb very high forces.

As shown in particular on FIG. 5, the float 8 has an annular shape of rectangular radial cross-section. It comprises radial partitions 21 evenly distributed around the main axis X1; in the example shown, there are eight partitions 21. The partitions 21 divide the float into eight independent watertight caissons. They also form stiffeners so that the float can withstand the water pressure. The float further comprises eight attachments 22. In the example of FIG. 5, each one is arranged on a lower edge 23 of the cylindrical outer wall 24 of the float. In the example shown, each attachment has the shape of a tab 22, formed in the radial extension of one of the eight respective radial walls. Each tab is designed to hold an upper end of a respective one of the eight tendons. A spherical guide allows the attachments to rotate freely.

Each upper end of a vertical tendon 17 is fixed to its respective tab 22, so that the tab cannot slide vertically, along the tendon.

Each upper end of an oblique tendon 18 is held at its respective attachment by a stop 26 (see FIG. 4), fixed to the tendon and arranged above the tab. Arranged in this way, the tab can transmit a tensile force to the tendon, but transmits virtually no buckling force. In addition, each upper or lower end of each tendon 17, 18 forms a ball joint with the respective attachment. Thus, virtually no compressive force is transmitted to the oblique tendons.

Each oblique tendon 18 is also connected, by a lower end, to its respective anchor by respective ball joint means. Each oblique tendon is arranged substantially in a vertical radial plane comprising the main axis X1. Each axial plane comprising an oblique tendon is angularly equidistant from two axial planes comprising a vertical tendon. Thus, the tendons are arranged alternately around the main axis X1. In other words, vertical tendons and oblique tendons are arranged alternately around this axis X1.

In the embodiment of FIGS. 1, 3, 4 and 8, the tendons are external, in other words they move away from the main axis X1 when going from top to bottom.

In the embodiment of FIG. 2, the tendons are internal, in other words they move closer to the main axis X1 when going from top to bottom. In the example of FIG. 2, the lower ends of the tendons 18 are substantially contiguous on the axis X1.

Preferably, the oblique tendons 18 form with the vertical an angle A18 greater than five degrees.

In the example shown on the figures, the extension 9 has a substantially frustoconical shape. It comprises inclined posts 31 evenly arranged around the main axis X1 and extending from bottom to top along generating lines of the conical shape. It also comprises hoops 32 arranged horizontally, connecting the posts together in order to prevent the posts from buckling under the weight of the seat and of the equipment, in this case of the wind turbine 3. The extension can, for example, be made of steel or concrete, or a combination of the two materials.

Due to the shape of the extension 9, forming an open framework, it is substantially transparent to the effects of wind and swell, which can pass through it with reduced forces.

The seat 10 has the shape of a spherical cradle, concave upwards, whose axis of revolution is the main axis X1 and whose centre of revolution is as close as possible to the axis of rotation X13 of the propeller 13. In the example shown, the seat comprises a structure 34 consisting of radial beams 35 and concentric rings 36. The beams extend substantially horizontally radially to the main axis X1, they are preferably made of metal and hollow near their neutral axis. This structure, composed of hollow beams and rings is thus lightened, giving the assembly 1 a low centre of gravity.

Amongst the concentric rings, the most central ring 36 C forms a cylindrical free passage 37 around the main axis X1.

In the example shown, the wind turbine mast is hollow, substantially tubular around the main axis X1; it rests on the seat. It has, firstly, a substantially spherical base 41, convex towards the bottom, designed to rest, at least indirectly, on the seat and to form a quasi-ball joint with the seat, and, secondly, a concave homothetic surface whose focus is that of the centre of the base. The centre of the spherical base 41 is approximately identical to the centre of revolution of the seat. For safety, this concave surface is guided with clearance in a cover whose lower part is convex spherical with a centre identical to that of the seat.

Several connecting means can be provided between the base 41 and the seat 10. For example, ball supports can be used. Elastic contacts can also be used, for example neoprene supports. The maximum angular displacements are in fact very low, approximately five hundredths of a degree, in other words, for a mast one hundred and twenty metres high, or more, a displacement of less than nine centimetres.

As shown in particular on FIG. 1, the wind turbine 3 comprises a rod 42 which extends substantially vertically downwards from the base 41 of the mast. The rod is substantially rigid and rigidly fixed to the base. The rod passes through the passage 37 in the seat 10. It carries, at a lower end, a mass 43. The mass is arranged inside the cylindrical inner space formed by the annular float 8. The rod 42 is preferably a steel tube. The mass 43 can be of any shape, it can in particular comprise a propeller of an electricity generator.

As shown in particular on FIG. 4, the platform 2 comprises an inflatable buoy 46 arranged under the seat 10, inside the extension 9. The buoy preferably has the shape of bellows and is made of a neoprene-type material. As shown on FIG. 8, the buoy is hollow and forms a cylinder which allows the rod 42 to pass through its inner space.

On FIG. 4, the buoy is shown deflated, so that it does not come into contact with the water. On FIG. 8, the buoy 46 is shown inflated so that it extends downwards, from the seat 10 to the inner space 44 of the float 8, below the surface S of the water.

During its inflation, the buoy is guided vertically by vertical guides 47. For each guide 47, the buoy comprises, on a lower peripheral edge 45, a respective slide 50 ensuring sliding guidance during inflation of the buoy. In the example shown on FIG. 4, there are three guides; there could be more.

Each of the guides is fixed firstly under the seat 10 and secondly to an internal wall 48 of the float, at a free end of a bracket 49 extending radially from the wall 48 towards the main axis X1. The brackets advantageously act as a stop for the downward deployment of the buoy during its inflation.

Preferably, in the inflated position, the lower edge of the buoy 46 is above a free flotation plane of the platform. Free flotation means the flotation of the platform when it is not pulled towards the seabed by the tendons 17, 18 but floats freely.

In its inflated position, the buoy forms with the float 8, the extension 9 and the base 10 a substantially rigid assembly.

The buoy represents a safety feature preventing the assembly 1 from being destroyed. Thus, for example, if one of the caissons of the float is no longer watertight or if a tendon breaks, the platform comprises means to inflate the buoy immediately to ensure the flotation of the assembly until the platform has been repaired.

The anchors 6 are advantageously suction anchors. They can also be fixed to piles. In order to install the anchors as precisely as possible, and to ensure that the tendons are arranged properly, a template is preferably used.

We will now describe a method for assembling a power generation assembly according to the invention, in reference to FIGS. 7 and 8.

According to the invention, the assembly is carried out at the port on an assembly line 100 comprising several stations. The line 100 shown on FIG. 7 comprises five stations P1-P5 distributed along a dock not shown, each station corresponding to a particular assembly phase.

A submersible barge, not shown, is used to move the assembly as it is being assembled, parallel to the dock, from one station to the next.

At the first station P1, the float described here being made of reinforced concrete, the formwork 99 acting as a mould for the concrete of the float is assembled on the barge. The reinforcements for the concrete are placed in the formwork. Inserts are included, in particular for the tabs 22 holding the tendons and pipes used to ballast the caisson.

At the second station P2, the concrete is poured, preferably continuously to avoid rework, which could lead to cracking that would impair the watertightness of the float. Once it has sufficient resistance, the float 8 is removed from the formwork. It is also possible to use a standard formwork described in the patent published under number FR 3 111 651, in the name of the company Coffratherm. At the third station P3, the extension 9 and the seat 10 are assembled on the float 8 thus produced.

At the fourth station P4, the wind turbine 3 is assembled on the platform 2 thus produced.

At the fifth station P5, with the assembly 1 thus produced, the barge is ballasted and evacuated between the port seabed and the float. It is now the float which ensures the flotation of the assembly 1.

A sixth phase P6 then starts, corresponding to the positioning of the assembly 1.

As shown on FIG. 8, the assembly 1 thus assembled is taken out to sea by tugs 102 to be anchored at its site of operation. In order to increase the stability of the assembly during towing, once out of the construction area and as soon as the water depth is sufficient, the centre of gravity of the assembly will be lowered. To do this, the caisson is ballasted while taking care to maintain positive buoyancy.

Preferably, three tugs are used in a star arrangement, two of which are shown on the figure.

The anchors 6 and the tendons 17, 18 are previously arranged on the seabed 4. The tendons are held substantially vertically. The assembly is directly above the anchors. If this has not been done in the towing phase, the buoy 46 is fully inflated and the float is ballasted, so that residual flotation is ensured by the buoy 46; the buoy is used to control the immersion depth of the float.

Once the float is at the correct depth, the vertical tendons 17 are attached first, then the oblique tendons 18.

The float 8 is then deballasted, thus placing the tendons 17, 18 under tension. The buoy 46 is then deflated. It is the inner volume of the float, filled with air, which then ensures the buoyancy of the assembly 1. Such an assembly can typically weigh 12 000 tonnes for a volume of 21 000 cubic metres.

The assembly is then operational and can enter the operating phase as soon as it is electrically connected to an electrical network or to an energy storage unit.

This type of assembly method minimises the operations to be carried out at sea. It also speeds up the production of a large number of assemblies. This is particularly advantageous for wind farms that can comprise several hundred wind turbines.

The inner volume of the underwater float is greater than that required to balance its own weight, the weight of all the equipment, including that of the wind turbine, and the vertical thrust of hundred-year waves exerted on this float while maintaining an upward resultant thrust; this upward thrust keeps at least the vertical tendons under tension. In addition, this inner volume is calculated so that the water draught of the assembly 1 is small enough to be able to evacuate the barge, at station 5, then to tow the assembly in the port where it was assembled, out to sea.

FIG. 9 shows oblique tendons consisting of a cable 101 stretched over pulleys 102 and forming a hoist-type system. In the example shown, a single cable is used.

Upper yokes 122 and respective pulleys 102 form attachments to attach the cable 101 to the float 8. Lower yokes 120 and respective pulleys 102 form attachments to attach the cable to respective anchors 6. Preferably, the yokes 120, 122 are hinged, so that the pulleys can orient themselves freely under forces exerted on each pulley by the tension of the cable 101.

As shown, when an anchor 6 comprises a single pulley 102, the opposite attachment 22 comprises two pulleys, and vice versa, when an anchor 6 comprises two pulleys 102, the opposite attachment comprises one pulley. Thus, each oblique tendon 18 consists of two strands 118 of the cable 101. These two strands 118 of the same tendon 18 are parallel with each other.

Each pulley 102 of an attachment comprising two pulleys is connected to another pulley of a neighbouring anchor which comprises two pulleys, by an inclined strand 119 of the cable 101.

Obviously, the invention is not limited to the examples which have just been described. On the contrary, the invention is defined by the following claims.

It will appear to those skilled in the art that various modifications can be made to the embodiments described above, in the light of the information that has just been disclosed.

Thus, instead of having a rectangular cross-section, the annular float can have a trapezoidal or any other cross-section; the float can also have a toric shape. In an embodiment not comprising a counter-balance, the float may not be annular and, thus, not comprise a central recess.

The float is preferably made of concrete. It can also be made of steel or any other material compatible with the forces applied to it and with the marine environment.

The hoops of the extension are shown in the form of arcs of a circle connecting two neighbouring posts. They can, for example, be replaced or completed by straight, horizontal or oblique rods, connecting two neighbouring posts or not.

The number of tendons can be different from that previously described, in other words four vertical tendons and four oblique tendons. There can be three or more tendons of each type.

Also, the number of tendons of one type can be a multiple of the number of those of another type. For example, there can be three oblique tendons and six oblique tendons; in this case, the alternation of the tendons can be: two vertical tendons followed by one oblique tendon, then two vertical tendons then an oblique tendon, etc.

Instead of being distributed on the outer periphery of the outer lower edge 23 of the float, all or some of the tabs 22 can be arranged on a lower edge of the inner wall 48.

The platform is suitable for any type of wind turbine, in particular of high power, greater than fifteen megawatts.

A platform of the type described can support any type of equipment, not necessarily a wind turbine. The equipment can for example be drilling equipment or have a surface intended to receive technical buildings or dwellings.

It appears that the arrangement of the tendons guarantees almost perfect stability of the assembly. The platform having thus become substantially insensitive to the effects of swell and wind, the electricity production is then only limited by the maximum permissible speed of rotation of the wind turbine blades. In addition, the stability of the assembly reduces maintenance costs and increase its lifetime.

1. A floating platform, being an offshore platform, to support equipment and organized around a substantially vertical main axis, comprising:
a float, tendons, attachments for attaching an upper end of each of said tendons to said float, and anchors for fixing a lower end of each of said tendons to a seabed,
said tendons comprising at least three tendons of a first type, arranged vertically, and at least three tendons of a second type, arranged obliquely, between their respective ones of the attachments and the anchors,
the types of tendons being arranged alternately around said main axis and being designed so that, in an operational position, said float is kept submerged at a depth below the a mean surface of water, and, at least the vertical tendons are kept taut.

2. The platform according to claim 1, wherein all the oblique tendons form a same angle with the main axis, the same angle being greater than five degrees.

3. The platform according to claim 1, wherein the oblique tendons are tubular rigid rods.

4. The platform according to claim 3, wherein each end of each of the tendons is hinged to one of the attachments or one of the anchors by a ball joint means.

5. The platform according to claim 3, wherein the attachments are designed to transmit only tensile forces to the upper ends of the oblique tendons.

6. The platform according to claim 1, wherein the oblique tendons consist of strands of a continuous cable stretched between pulleys carried by the float and pulleys carried by respective anchors.

7. The platform according to claim 1, wherein the float is of revolution around the main axis, wherein the float is annular.

8. The platform according to claim 1, further comprising an extension and a seat for said equipment, said seat being arranged on said extension, said extension extending upwards from the float, and being designed so that in a use position, there is an air draught under said seat.

9. The platform according to claim 8, wherein the extension comprises a swell and wind transparent lattice structure.

10. The platform according to claim 1, further comprising an inflatable buoy capable of ensuring flotation of the platform if the float fully ballasted.

11. An assembly, comprising a platform according to claim 1, and equipment supported by said platform.

12. The assembly according to claim 11, further comprising an extension and a seat for said equipment, said seat being arranged on said extension, said extension extending upwards from the float, and being designed so that in a use position, there is an air draught under said seat, wherein the equipment comprises a base which forms a swivelling mechanism with the seat of said platform.

13. The assembly according to claim 12, wherein the equipment comprises counterweights which extend downwards from the base through the platform, said counterweights comprising a rod extending downwards from said base and a mass fixed to a lower end of said rod, said seat comprising an axial passage for said rod.

14. The assembly according to claim 12, wherein the equipment is a wind turbine comprising a propeller having an axis of rotation and wherein the swivelling mechanism has a centre of rotation substantially on said axis of rotation.

15. A method for assembling a the platform according to claim 9, the method comprising steps of:
providing a dock;
arranging several assembly stations along said dock;
providing a submersible barge;
placing the barge at one or more stations to manufacture the float; then,
placing the barge at one or more stations to assemble the extension and the seat; then,
placing the barge at one or more stations to assemble the equipment on said platform; then,
placing the barge on another station; then
ballasting the barge until the float alone ensures the flotation of the assembly thus assembled.

16. A method for mooring an the assembly according to claim 12, the platform including an inflatable buoy capable of ensuring flotation of the platform if the float is fully ballasted, the method comprising steps of:
placing the anchors according to a template, at a desired position;
fixing the tendons to said anchors;
bringing the assembly by floating above said position;
inflating the buoy;
ballasting the float until it is sufficiently submerged;
fixing the upper ends of said tendons to the float;
deballasting the float;
deflating the buoy.

17. The platform according to claim 8, wherein the extension comprises a swell and wind transparent structure comprising posts and substantially horizontal bars connecting the posts together.
